(19) United States
(12) Patent Application Publication
(10) Pub. No.: US 2006/0019234 A1
(43) Pub. Date: Jan. 26, 2006

(54) Modern blood banking employing improved cell preservation composition

(75) Inventor: Edward Shanbrom, Santa Ana, CA (US)

Correspondence Address: LINER YANKELEVITZ SUNSHINE AND REGENSTREIF, 1100 GLENDON AVENUE, 14TH FLOOR, LOS ANGELES, CA, 90024, US

(73) Assignee: Shanbrom Technologies, LLC

(21) Appl. No.: 10/897,632

(22) Filed: Jul. 22, 2004

(51) Int. Cl. A01N 1/02

(52) U.S. Cl. 435/2

(57) ABSTRACT

An improved anticoagulant is based on a higher level of citric acid than is usual (at least about 0.2% weight by volume). The higher citrate is combined with an amino acid as a counterion. The amino acid prevents cellular damage often caused by elevated citrate levels. The amino acid citrate mixture also serves to preserve platelet concentrates and platelet rich plasma during room incubation. Not only does the amino acid citrate combination enhance platelet integrity, it completely inhibits the growth of bacteria such as Staphylococcus epidermidis. Collecting blood of plasma into such higher levels of citrate prevents activation of blood proteins so that fractions made from the blood or plasma have superior characteristics.

### BACKGROUND OF THE INVENTION

1. Area of the Art

The present invention is in the area of blood banking and compositions to preserve the viability of biological cells and more specifically for compositions to preserve the viability of blood cells and blood banking procedures based thereon.

2. Description of the Prior Art

Transfusion of whole blood and of components fractionated from whole blood is a common and well-accepted part of modern medical practice. Not only is blood transfused to replace losses due to accident or surgery, but also cellular components such as platelets are often transfused to correct disease-induced insufficiency of the cellular component.

Today we are accustomed to the idea of a blood bank where blood is removed from donors and stored and/or fractionated for later use. It comes somewhat as a surprise to realize that the first such blood banks were not established until the 1930's and did not become common in the United States until after the Second World War. Thus, the blood bank is only fifty or so years old as a common part of the medical scene. The relatively recent understanding of the factors required for successful blood transfusion explains this comparatively recent advent of blood banking.

One of the biggest problems in blood transfusion is the tendency of blood to clot once removed from the circulatory system. If blood is exposed to the atmosphere or comes into contact with any of a number of non-biological surfaces, the blood clotting reactions begin with the fluid becoming transformed into a gel. Many early attempts at transfusion resulted in the transfused blood becoming clotted—with more or less disastrous consequences for the recipient. We now know that exposure of blood to damaged tissues or foreign surfaces starts an “activation” process in which an incredible biochemical cascade in which specialized proteases in the blood cleave proenzymes to release or activate other proteases which activate other components, and so on and so on. Sodium citrate was first introduced in 1915 as an anticoagulant to prevent or slow this activation process. Within the next year or so glucose was added to the citrate to extend the life of anticoagulated blood.

By the 1920's the basic outlines of blood banking had been established. Blood is withdrawn from a donor's vein into a container holding concentrated sodium citrate and glucose to prevent activation of the clotting mechanism and to provide energy for the blood cells during storage. The stabilized blood is then stored under refrigeration and transfused into the vein of a donor after a cross-matching procedure indicted that the donor and recipient were compatible. It was not until 1979 that further improvements were made to anticoagulants. At that time CPDA-1 was introduced as an improved anticoagulant to replace ACD. CPDA-1 added adenine to the traditional anticoagulant allowing whole blood and red bloods cells to have a 35-day shelf life.

Yet, there are many shortcomings in current blood banking practices. Perhaps the most pressing problem is the potential for spreading blood borne viruses and other pathogens. This problem is presently dealt with by screening tests and disinfection technology. A second problem is limits to shelf life due to contaminating bacteria. This is an especially acute problem with platelet concentrates, which generally must be stored at room temperature. Since it is virtually impossible to avoid some bacterial contamination when blood is withdrawn from a donor, platelet concentrates must be used in less than seven days to avoid an overgrowth of bacteria.

Finally, there are growing indications that many of the fractions produced from donated blood are somewhat suboptimal. This may partly be due to damage occurring during the fractionation process itself. However, the present inventor believes that some problems are caused by low level or so-called cryptic activation of the clotting enzymes. Such activation is not sufficient to actually cause a clot, but the activated proteases cause damage to many blood proteins resulting in suboptimal properties to various blood fractions.

An inspection of all the common anticoagulants used currently to collect blood shows that they all contain approximately 0.04% citrate by weight. As explained below, there are valid data showing that a higher level of citrate than 0.04% citrate prevents or greatly reduces cryptic activation of enzymes. However, the present anticoagulants were formulated to give maximum blood cell life, which also means that the anticoagulant must cause negligible cell damage. Levels of sodium citrate (or soluble citrate salts of other metallic cations) that are appreciably higher than 0.04% citrate by weight (say 0.08%) can cause significant cellular damage. Furthermore, there is a pervasive belief that 0.04% citrate is more than adequate. Therefore, the anticoagulants were optimized to prevent cell damage with little regard for cryptic activation of blood proteins.

### SUMMARY OF THE INVENTION

Fractions made from blood and plasma are superior because activation and resulting protein damages are avoided. Optimum anticoagulation requires a higher level of citrate—about 0.2% by weight or greater. However, elevated citrate levels may result in damage to cellular components—red blood cells and platelets, especially. Surprisingly providing the elevated citrate in the form of a citrate salt of a basic amino acid avoids this problem. Citrate amino acid anticoagulant not only prevents red cell damage, it inhibits bacterial growth in room temperature platelet concentrates while preserving platelet structure and function.

Following collection at optimal citrate levels still higher citrate concentrations can be use to produce enhanced cryoprecipitate. Such cryoprecipitate is free from activation damage and can be used to produce fibrin glue or sealant. The cryo-depleted plasma is then fractionated into an albumin and an immunoglobulin fraction. These fractions show superior properties because the source plasma has never become even slightly activated.

The improved anticoagulant and related procedures are especially amenable to use in a hospital blood bank because they are relatively simple to carry use. The resulting products can be readily used within the hospital and can also represent an enhanced source of revenue for the blood bank.

### DETAILED DESCRIPTION OF THE INVENTION

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein specifically to provide an improved anticoagulant/cell preservative for blood as well as related blood bank processes.

The present inventor has previously discovered that higher levels of citrate result in improved cryoprecipitation (U.S. patent application Ser. No. 09/778,681, now issued as U.S. Pat. No. 6,541,518) and further serve as a germicide to preserve cellular concentrates such as platelet concentrates. It was hoped that collection into anticoagulants containing higher levels of citrate would provide many benefits. However, optimal cryoprecipitation, which involves an interaction between proteins and citrate the present inventor terms “citrification,” requires citrate levels of approximately 10-12% by weight-levels much too high for use in blood collection. Even improved preservation of platelets was found to require citrate levels that are potentially damaging to red blood cells when “traditional” citrate salts such as sodium or potassium citrate are employed.

As mentioned above, the currently used citrate anticoagulant level (0.04%) is believed to be inadequate to prevent cryptic activation of the blood proteins. In the past it has been difficult to detect such activation; however, tools are now available that make it relatively simple to demonstrate the inadequacy of current citrate levels. When the clotting enzymes become active, fibrinogen is ultimately cleaved into fibrin, which polymerizes to form a clot. Cryptic activation results in such small aggregations of fibrin that an actual clot is generally not visible. Blood also contains a clot reversing system that ultimately cleaves any fibrin formed. The fragments of cleaved fibrin are known as D-dimers. The presence of D-dimers in a blood sample is an indication that the clotting enzymes had become activated at some time, forming fibrin that was ultimately cleaved to release D-dimers. That is, D-dimers are an indication of past activation of enzymes in a sample.

To demonstrate the presence of cryptic activation 34 freshly drawn, citrated plasma samples (standard 0.04% sodium citrate anticoagulant) were obtained. The samples were divided into four 1 ml aliquots. To three of the sample aliquots, sufficient concentrated citrate solution was added to achieve 1%, 1.5% or 2% weight/volume citrate, respectively, while the fourth aliquot acted as the control.

As a “worst case” scenario to detect activation, the aliquots were incubated at 21° C. for a maximum of ten days. Each aliquot was assayed daily for the presence of D-dimers using the DimerTest latex agglutination assay (American Diagnostica, Stamford, Conn.). The results are shown in Table 1 where the number of days to observable D-dimers is listed for each aliquot. In the table “n/a” means that no D-dimers were ever observed, thus indicating that no activation has occurred in that sample. At day six of incubation, 41.2% (14) of the control aliquots were positive for the presence of D-dimers. By day seven, 100% (34) of the non-citrated aliquots were positive for D-dimers. None of the samples showed visible clots. None of the aliquots with additional citrate showed D-dimers by day ten of the incubation period. These results demonstrate that traditional levels of citrate are inadequate to completely suppress clotting enzyme activation.

TABLE 1

| | 0.04% | 1% | 1.5% | 2% |
|---|---|---|---|---|
| Sample | Citrate | Citrate | Citrate | Citrate |
| #1 | 6 | n/a | n/a | n/a |
| #2 | 7 | n/a | n/a | n/a |
| #3 | 7 | n/a | n/a | n/a |
| #4 | 7 | n/a | n/a | n/a |
| #5 | 7 | n/a | n/a | n/a |
| #6 | 6 | n/a | n/a | n/a |
| #7 | 7 | n/a | n/a | n/a |
| #8 | 6 | n/a | n/a | n/a |
| #9 | 6 | n/a | n/a | n/a |
| #10 | 7 | n/a | n/a | n/a |
| #11 | 6 | n/a | n/a | n/a |
| #12 | 6 | n/a | n/a | n/a |
| #13 | 7 | n/a | n/a | n/a |
| #14 | 7 | n/a | n/a | n/a |
| #15 | 7 | n/a | n/a | n/a |
| #16 | 7 | n/a | n/a | n/a |
| #17 | 7 | n/a | n/a | n/a |
| #18 | 7 | n/a | n/a | n/a |
| #19 | 6 | n/a | n/a | n/a |
| #20 | 7 | n/a | n/a | n/a |
| #21 | 7 | n/a | n/a | n/a |
| #22 | 7 | n/a | n/a | n/a |
| #23 | 7 | n/a | n/a | n/a |
| #24 | 6 | n/a | n/a | n/a |
| #25 | 6 | n/a | n/a | n/a |
| #26 | 7 | n/a | n/a | n/a |
| #27 | 6 | n/a | n/a | n/a |
| #28 | 5 | n/a | n/a | n/a |
| #29 | 6 | n/a | n/a | n/a |
| #30 | 7 | n/a | n/a | n/a |
| #31 | 6 | n/a | n/a | n/a |
| #32 | 7 | n/a | n/a | n/a |
| #33 | 6 | n/a | n/a | n/a |
| #34 | 7 | n/a | n/a | n/a |

Since it is clear that higher levels of citrate are needed to prevent cryptic activation, the inventor set out to find a way to achieve the benefits of higher citrate concentrations without causing cellular damage. When levels of citrate are used that are significantly above the standard 0.04% by weight, there is swelling of the red cells and/or release of enzymes and hemoglobin from the red cells—all these changes are indicative of some type of damage to the cell. It was suspected that the problem might be that red cell membranes have mechanisms that allow the penetration of cations like sodium as well as mechanisms allowing uptake of citrate. This results in an osmotic imbalance if the cells take up both sodium and citrate. If a non-permeable counterion to citrate could be used, citrate uptake might be severally limited due charge considerations.

Following this line of reasoning various counterions to citrate were considered. Although those of skill in the art of organic chemistry can point to a large number of suitable water-soluble anionic counterions for use with citric acid, the goal of the present invention is to use the citrate treated blood for transfusion purposes, so that many potential counterions are prohibited at least until safety studies are undertaken. One apparently safe type of counterion would be basic amino acids since these compounds are water soluble, non-toxic and believed to be safe for intravenous administration. Experiments have been carried out with both lysine and arginine; the results are comparable so most experiments now use lysine to simplify the tests.

Preservation of Platelets

Anticoagulated blood (0.04% citrate by weight) was centrifuged to produce platelet Rich Plasma (PRP). To test samples of PRP citric acid, 1% by weight, along with lysine, 0.5% by weight, was added. Following this addition the pH was 6.7. It will be apparent to one of skill in the art that the precise ratio of basic amino acid to citrate can be altered to adjust the pH of the solution. One sample of original PRP was used as the Normal Control, and one sample of the lysine citrate PRP was used as the Citrate Control. One sample of original PRP was inoculated with cultured Staphylococcus epidermidis to a final concentration of about 10 cfu/ml—this formed the Spiked Normal. Similarly, one aliquot of lysine citrate PRP was inoculated with Staphylococcus epidermidis to a final concentration of about 10 cfu/ml to form the Spiked Citrate. The samples were incubated at room temperature for five days. Each day the number of platelets in each sample was counted; each sample was also tested for LDH (lactate dehydrogenase) and for the ability to induce a clot. Following the tests an aliquot of each sample was subcultured on nutrient agar and incubated under growth conditions. The results of the non-bacteriological tests are given below in Table 2 while the bacteriological tests are shown in Table 3.

TABLE 2

| | | Normal Control | Spiked Normal | Citrate Control | Spiked Citrate |
|---|---|---|---|---|---|
| Day 1 | Count (per μl) | 3.1 × 10⁵ | 3 × 10⁵ | 3.2 × 10⁵ | 2.99 × 10⁵ |
| | LDH (IU/L) | 130 | 128 | 133 | 131 |
| | Clot time (sec) | 32 | 30 | 35 | 29 |
| Day 2 | Count | 3.0 × 10⁵ | 2.9 × 10⁵ | 3.1 × 10⁵ | 3.0 × 10⁵ |
| | LDH | 131 | 130 | 133 | 130 |
| | Clot time | 32 | 30 | 30 | 32 |
| Day 3 | Count | 3.1 × 10⁵ | 2.5 × 10⁵ | 3.3 × 10⁵ | 3.0 × 10⁵ |
| | LDH | 140 | 143 | 134 | 133 |
| | Clot time | 35 | 39 | 32 | 30 |
| Day 4 | Count | 3.3 × 10⁵ | 1.9 × 10⁵ | 3.5 × 10⁵ | 3.2 × 10⁵ |
| | LDH | 143 | 158 | 133 | 131 |
| | Clot time | 36 | 60 | 35 | 30 |
| Day 5 | Count | 3.2 × 10⁵ | 1.5 × 10⁵ | 3.1 × 10⁵ | 3.0 × 10⁵ |
| | LDH | 149 | 188 | 135 | 131 |
| | Clotting time | 38 | >120 | 33 | 32 |

TABLE 3

| Colony Counts | Day 1 | Day 2 | Day 3 | Day 4 | Day 5 |
|---|---|---|---|---|---|
| Normal Control | 0 | 0 | 0 | 0 | 0 |
| Spiked Normal | 10 | 200 | >250 | >250 | >250 |
| Spiked Citrate | 10 | 7 | 5 | 9 | 7 |

Table 2 shows that the platelet count for the Normal Control remained essentially unchanged over the five-day period. This is consistent with current procedure that permits platelet concentrates to be stored for as long as five days. However, over this time there was an increase of LDH (which leaks from damaged platelets) and a slight increase in clotting time, most likely a reflection of damaged platelets. In the Spiked Normal the number of platelets declined significantly while the LDH and clotting time increased greatly—all these signifying the deterioration of the platelets due to bacterial growth. In the Citrate Control, the number of platelets, LDH level and clotting time remained essentially unchanged over the five-day period demonstrating the preservative effect of the amino acid citrate combination. Even more significant is the measurement of the Spiked Citrate over the five days—like the Citrate Control, the various criteria remained essentially unchanged.

Table 3 provides further insight. The Normal Control showed no bacteria when plated out. This indicates that the PRP in this experiment is essentially axenic—something that is not at all guaranteed with collected blood. Therefore, the slight deterioration seen over the five days should be due entirely to platelet damage (possibly from the anticoagulant) or aging of the platelets as opposed to an effect of bacterial contaminants. The Spiked Normal shows tremendous bacterial growth after the second day as might be expected. This shows why the normal contamination of blood samples with Staphylococcus epidermidis is such a huge problem. If only a few bacterial cells from the donor skin surface get mixed into the blood, the samples can be essentially destroyed within a few days. Just like the Normal Control, the Citrate Control showed no bacteria following plating onto nutrient agar. The Spiked Citrate results, however, are very interesting because essentially the same small number of bacteria is recovered each day. This indicates that while the amino acid citrate does not kill the added bacteria, it essentially completely inhibits their growth. Thus, addition of amino acid citrate to platelets preserves platelet functions and prevents multiplication of any contaminating bacteria. Since the platelets are essentially completely unchanged after five days, amino acid citrate treatment can readily extend the life of platelet concentrate to seven days, if not much longer. Since the amino acid citrate stabilizes the platelets and inhibits bacterial growth, it is anticipated that addition of growth factors or energy sources (e.g., sugars) will further extend platelet life. Formerly, such additions were not possible, as they would merely accelerate bacterial growth.

Preservation of Red Blood Cells

As demonstrated above, collection of blood into levels of citrate significantly higher than the traditional 0.04% by weight results in significant reduction in activation of plasma proteins. However, significantly increasing the level of sodium citrate also results in red blood cell damage. In this experiment whole blood (an aliquot of which clotted within 10 minutes without anticoagulant) was modified by adding a number of different anticoagulant compositions. Sodium citrate was used as an anticoagulant at 0.25%, 0.35% and 0.5% by weight. These are all higher citrate levels than the usual 0.04% by weight. Amino acid citrates (lysine or arginine) were used at 0.25%, 0.35% and 0.5% by weight based on the weight of the citric acid. The amino acid counterion was used at a weight percentage of 0.5 relative to the citrate weight percentage. Table 4 shows the clotting times (PT=prothrombin time and PTT partial prothrombin time) for the anticoagulated bloods after four hours storage at room temperature.

TABLE 4

| | PT (seconds) | PTT (seconds) |
|---|---|---|
| Anticoagulant | (4 hrs at RT) | (4 hrs at RT) |
| Na Citrate | 13.1 | 28.7 |
| 0.25 wgt %. | | |
| Na Citrate | 14.1 | 31.5 |
| 0.35 wgt %. | | |
| Na Citrate | 21.2 | 35.0 |
| 0.50 wgt %. | | |
| Arg Citrate | 15.8 | 36.8 |
| 0.25 wgt %. | | |
| Arg Citrate | 20.2 | 39.9 |
| 0.35 wgt %. | | |
| Arg Citrate | 55 | 56.8 |
| 0.50 wgt %. | | |
| Lys Citrate | 14.1 | 33.8 |
| 0.25 wgt %. | | |
| Lys Citrate | 16.6 | 33.2 |
| 0.35 wgt %. | | |
| Lys Citrate | 36.5 | 44.4 |
| 0.50 wgt %. | | |

The normal PT clotting time is about 11-13 seconds, and the normal PTT clotting time is less than about 33 seconds. Therefore, PT clotting time for the 0.25% sodium citrate was about normal. All of the other anticoagulants showed clotting times slightly to significantly longer than normal. Both of the amino acid citrate anticoagulants are more effective anticoagulants than sodium citrate (as judged by ability to inhibit clot formation in this test).

Table 5 shows the effects of the different anticoagulants on red blood cell integrity over time. To judge red cell condition the blood was counted and various other measurements were taken initially and after 20 and 33 days of storage at 4° C. Apparent differences in RBC counts are due to dilution caused by adding extra anticoagulant. Mean cell volume (MCV) is a red cell index that is a useful measure of red cell health. An increase in MCV indicates that the normally biconcave red cells are undergoing a change to a spherical shape occasioned by loss of cellular energy and general cell senescence and damage. It is believed that a citrate level of at least about 0.5% by weight (i.e., more than ten times the usual amount) can be necessary to ensure against all activation of plasma proteins. These results show that sodium citrate levels of 0.25% by weight or higher also cause unacceptable swelling of red cells during storage. On the other hand, amino acid citrates, which are very effective anticoagulants, are also effective at preventing red cell damage.

TABLE 5

| | RBC (10⁶/μl) | MCV | MCV |
|---|---|---|---|
| Anticoagulant | Day 1 | Day 20 | Day 33 |
| Na Citrate | 5.43 | 97.1 | 94.3 |
| 0.25 wgt %. | | | |
| Na Citrate | 5.86 | 98.7 | 103.2 |
| 0.35 wgt %. | | | |
| Na Citrate | 6.07 | 97.8 | 103.3 |
| 0.50 wgt %. | | | |
| Arg Citrate | 5.77 | 93.1 | 93.5 |
| 0.25 wgt %. | | | |
| Arg Citrate | 6.45 | 92.6 | 93.6 |
| 0.35 wgt %. | | | |
| Arg Citrate | 6.77 | 91.5 | 92.4 |
| 0.50 wgt %. | | | |
| Lys Citrate | 5.37 | 93.0 | 93.8 |
| 0.25 wgt %. | | | |
| Lys Citrate | 6.78 | 92.7 | 92.7 |
| 0.35 wgt %. | | | |
| Lys Citrate | 5.82 | 92.2 | 92.9 |
| 0.50 wgt %. | | | |

These results demonstrate an entirely new anticoagulant system that will result in revised Blood Bank procedures. The goal should be to collect blood into an elevated (compared to traditional anticoagulants) level of amino acid citrate. The citrate level should be between about 0.2 and 1% citrate (citric acid) by weight with around half the weight percent of amino acid (about 0.5% by weight for 1% citrate) to adjust the pH and prevent cell damage. The precise ratio of citrate to amino acid can be altered to adjust the pH of the solution. The actual level of citrate can be higher, but there appears to be little advantage to increased levels above about 1% by weight. Similarly, the level can be somewhat lower than 0.2% by weight but the possibility for cryptic activation increases at lower levels. It is envisioned that the other usual additives such as phosphate and dextrose would be included. The higher level of citrate will prevent any cryptic activation. If platelet concentrates are produced from blood treated with the new anticoagulants, the elevated citrate will preserve the platelets and prevent bacterial growth giving the concentrate a room temperature life of at least seven days. Red blood cells separated from the blood will have greater stability and shelf life without freezing. Although bacterial growth at 4° C. (red cell storage temperature) is much slower than at room temperature, the amino acid citrate also inhibits low temperature bacterial growth and acts as extra insurance against inadvertent bacterial contamination.

The following Table 6 shows possible amino acid anticoagulant mixtures for use in a 500 ml blood collection bag. These are “1%” citrate formulae; it will be appreciated that the actual level of citrate can be adjusted within its useable range. It will also be appreciated by those of skill in the art that adjustments of pH or osmolality may be required for optimum results.

TABLE 6

| | Formula A | | Formula B | | Formula C | | Formula D | |
|---|---|---|---|---|---|---|---|---|
| Additive | 70 | ml | 70 | ml | 70 | ml | 70 | ml |
| Volume | | | | | | | | |
| Citric Acid | 5 | g | 5 | g | 5 | g | 5 | g |
| Lysine | 2.5 | g | | | 2.5 | g | | |
| Arginine | | | 2.5 | g | | | 2.5 | g |
| Adenine | | | | | 20 | mg | 20 | mg |
| Dextrose | 1.8 | g | 1.8 | g | 2.25 | g | 2.25 | g |
| Sodium | 155 | mg | 155 | mg | 155 | mg | 155 | mg |
| Phosphate | | | | | | | | |

In the cases where the collected blood is separated into a cellular component and a plasma component, the initial higher citrate level provides superior plasma by preventing cryptic activation with associated protein damage. In almost all cases the plasma will go though additional fractionation steps. The plasma can be frozen and fractionated according to the traditional schemes. However, there are significant advantages to adding additional sodium and/or potassium citrate to “citrify” the proteins and directly produce a “super-cryoprecipitate” according to U.S. Pat. No. 6,541,518. All of the usual products can be made from the super-cryoprecipitate. The cryo-depleted plasma that results is superior to ordinary depleted plasma because it has less fibrinogen than depleted plasma made according to the traditional methods. In addition, since cryptic activation was prevented, the depleted plasma has increased amounts of protease inhibitors and other labile plasma proteins. It is then possible to lower the citrate level and process the cryo-depleted plasma according to traditional fractionation techniques.

There are at least two viable methods for removing citrate from plasma or any of the fractions. The first method involves passing the plasma or plasma fraction through an anion exchange column containing a resin having affinity for the citrate anion. A number of anion exchange resins have significant citrate affinities so that if the plasma is passed through a column containing the chloride form of such a resin, passage will effectively exchange chloride for citrate. Most strong base anion exchange resins are ideal, but a number of weak base anion exchange resins are also effective. Those of skill in the art will be readily able to compute the optimum size of column to replace a given amount of citrate at a given flow rate. Alternatively, there are well-known methods for analyzing column effluent so that ideal operating conditions will be readily attained. It is important to recognize that whole plasma and certain plasma fractions remain capable of clot formation so that with such fractions care must be taken not to remove too much of the citrate. A second consideration is the fact that citrate may act as a significant buffer so that removal can result in pH changes.

A second effective method for removing citrate is to titrate the plasma or fraction with a soluble calcium salt—for example, calcium chloride. As calcium citrate is highly insoluble, there will be an almost quantitative conversion of calcium into calcium citrate, which can then be removed by filtration or centrifugation. Again, it is relatively simple to compute the calcium addition to leave adequate residual citrate to ensure lack of clot formation. The same caveats concerning pH changes apply here. Addition of calcium as a solution has the drawback of somewhat diluting the fraction; there is nothing to prohibit adding the calcium as a solid so that such dilution can be avoided.

Once the excess citrate has been removed, traditional fractionation techniques may be employed. Interestingly, there are some data that indicate that higher levels of citrate anticoagulation have advantages beyond avoiding cryptic activation. In the following experiment aliquots of plasma were either anticoagulated using traditional anticoagulants (0.04% w/v citrate) or “high citrate” (1% w/v citrate). The samples were then cooled to yield enhanced cryoprecipitate as is well known in the art. The enhanced cryoprecipitate is useful either for the “traditional” use as a source of clotting factors or for providing high quality fibrin “glue” or fibrin “sealant.” The higher level of fibrinogen—as compared to traditional cryoprecipitate—makes the sealant application especially attractive. The remaining cryo-depleted plasma was further fractionated into an Albumin III fraction and an Immunoglobulin fraction. The fractions were challenged by inoculation with mixed bacterial inoculum A, B, or C which are listed in order of number of bacteria added—that is inoculum C contains more bacterial than inoculum A. After incubation for 12 hr samples were taken of each fraction and streaked onto nutrient agar plates. The plates were incubated and then scored for bacteria growth. The hypothesis tested is that cryptic activation of plasma depletes natural antibacterial constituents.

As shown in Tables 7 (inoculum A), 8 (inoculum B) and 9 (inoculum C), this hypothesis appears valid. In Table 7 none of the high citrate fractions showed any bacterial growth. This indicates the presence of natural antibacterial substances in the fractions. That immunoglobulins would show antibacterial activity is not as surprising as the activity shown by cryoprecipitate and albumin III. In contrast the low citrate fractions failed to show antibacterial activity in the albumin fraction. This antibacterial activity could be very important for sepsis treatment where the toxin absorbing character of albumin could be enhanced by the inherent antibacterial properties. Table 8 shows that with inoculum B all the high citrate fractions continued to show no bacterial growth whereas both the cryoprecipitate and the Albumin III fraction of the low citrate showed bacterial growth. Table 9 shows that the extreme challenge of inoculum C produced bacterial growth in both the high and the low citrate fractions although there was less growth in the high citrate fractions.

TABLE 7

| | High Citrate | Low Citrate |
|---|---|---|
| Cryoprecipitate | no growth | no growth |
| Immunoglobulin | no growth | no growth |
| Albumin III | no growth | ++ |

TABLE 8

| | High Citrate | Low Citrate |
|---|---|---|
| Cryoprecipitate | no growth | + |
| Immunoglobulin | no growth | no growth |
| Albumin III | no growth | +++ |

TABLE 9

| | High Citrate | Low Citrate |
|---|---|---|
| Cryoprecipitate | +++ | ++++ |
| Immunoglobulin | + | ++++ |
| Albumin III | ++++ | ++++ |

The modern blood banking procedures envisioned by the present invention start by collecting the blood into an enhanced amino acid citrate anticoagulant. This new anticoagulant prevents cryptic activation while preserving both red cells and platelets. At the same time bacterial growth is prevented—an especially important factor in providing platelet concentrates with longer shelf life. Plasma either with the cellular materials removed or plasma collected without cellular materials (e.g., by plasmapheresis) then benefits from addition of even more citrate (in the form of the sodium or potassium salts) so that enhanced cryoprecipitate can be generated. At the modern blood bank the enhanced cryoprecipitate can be readily used to make as fibrin glue or sealant. The high levels of fibrin recovery make autologous fibrin sealant a distinct possibility for voluntary surgery. Not only does this represent increased safety for the patient, it also represents an important revenue source for the blood bank. Fractions locally produced from the cryo-depleted plasma can also generate revenue as well as enhancing the quality of patient care. The enhanced antibacterial characteristics make these fractions superior for essentially all patients. Because the improved anticoagulants prevent cryptic activation, the Albumin III fraction has much higher levels of protease inhibitors (serpins) than traditional fractions. Therefore, this fraction is ideal for patients with advanced liver disease—another way the modern blood bank can support work of the hospital. Finally, the immunoglobulin fraction can advantageously be used for treatment of a variety of infectious diseases. Fractionation of non-activated plasma produces a superior fraction that is less likely to cause reactions, etc.

The following claims are thus to be understood to include what is specifically illustrated and described above, what is conceptually equivalent, what can be obviously substituted and also what essentially incorporates the essential idea of the invention. Those skilled in the art will appreciate that various adaptations and modifications of the just described preferred embodiment can be configured without departing from the scope of the invention. The illustrated embodiment has been set forth only for the purposes of example and that should not be taken as limiting the invention. Therefore, it is to be understood that, within the scope of the appended claims, the invention may be practiced other than as specifically described herein.

1. An improved method for anticoagulating blood comprising the step of collecting the blood into a mixture including citric acid at a concentration of at least about 0.8% weight by volume and an amino acid at a concentration of about one half the weight percentage of the citric acid.

2. The method according to claim 1, wherein the amino acid is a basic amino acid.

3. The method according to claim 2, wherein the amino acid is selected from the group consisting of lysine and arginine.

4. The method according to claim 1, wherein the citrate concentration is between about 0.8% weight by volume and about 1.5% weight by volume.

5. An improved method for preserving platelet concentrates and platelet rich plasma comprising the step of adding citric acid at a concentration of at least about 0.8% weight by volume and an amino acid at about one half the weight percentage of the citric acid.

6. The method according to claim 5, wherein the amino acid is a basic amino acid.

7. The method according to claim 6, wherein the amino acid is selected from the group consisting of lysine and arginine.

8. The method according to claim 5, wherein the citrate concentration is between about 0.8% weight by volume. and about 1.5% weight by volume.

9. An improved anticoagulant for blood collection comprising:
citric acid sufficient to make a final concentration in collected blood of at least about 0.8% weight by volume; and
an amino acid sufficient to make a final concentration in collected blood of about one half the weight percentage of the citric acid.

10. The method according to claim 9, wherein the amino acid is a basic amino acid.

11. The anticoagulant according to claim 10, wherein the basic amino acid is selected from the group consisting of lysine and arginine.

12. The anticoagulant according to claim 9, wherein the citrate concentration is between about 0.8% weight by volume and 1.5% weight by volume.

13. The anticoagulant according to claim 9, further comprising dextrose.

14. The anticoagulant according to claim 9, further comprising adenine.

15.-18. (canceled)

19. An improved preservative solution comprising:
citric acid sufficient to make a final concentration of at least about 0.8% weight by volume; and
an amino acid sufficient to adjust the pH of the preservative solution.

20. The solution according to claim 19, wherein the amino acid is selected from the group consisting of lysine and arginine.

21. An improved preservative solution for biological fluids comprising:
citric acid sufficient to make a final citrate concentration of at least about 0.8% weight by volume when the improved preservative solution is added to a biological fluid; and
lysine sufficient to adjust the pH of the preservative solution to between about pH 6.0 and pH 7.0.
